(19) United States
(12) Patent Application Publication
(10) Pub. No.: US 2011/0037394 A1
(43) Pub. Date: Feb. 17, 2011

(54) Light Emitting Diode Lamp

(75) Inventors: Yu-Chen Lin, Kaohsiung County (TW); Po-Ming Tsai, Kaohsiung County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: GREAT TOP TECHNOLOGY CO., LTD., Kaohsiung County (TW)

(21) Appl. No.: 12/711,492

(22) Filed: Feb. 24, 2010

(30) Foreign Application Priority Data
Aug. 14, 2009 (TW) 098215024

(51) Int. Cl. H05B 37/02

(52) U.S. Cl. 315/149; 315/362

(57) ABSTRACT

A light emitting diode lamp includes a housing having a first side mounted with a conductive connecting head, and a second side opposite to the first side. The second side of the housing has a first mounting surface, and a tapered protrusion projecting outwardly from the first mounting surface and having at least one inclined second mounting face inclined with respect to the first mounting surface. A lighting unit includes a plurality of first light emitting diodes mounted on the first mounting surface of the housing, and a plurality of second light emitting diodes mounted on the second mounting face of the housing. A driving unit is disposed in the housing and is coupled to the lighting unit and the conductive connecting head for activating the lighting unit. A transparent cap body is mounted on the second side of the housing for covering the lighting unit.

### BACKGROUND OF THE INVENTION

1. Field of the Invention

The invention relates to a lamp, more particularly to a light emitting diode lamp.

2. Description of the Related Art

FIG. 1 illustrates a conventional light emitting diode lamp 1 that includes a transparent bulb body 12, and a mounting seat disposed in the bulb body 12 and having a flat mounting surface 121, and a plurality of light emitting diodes 11 mounted on the mounting surface 121. In such a configuration, the conventional light emitting diode lamp 1 merely provides an illumination angle of about 120° and cannot achieve omnidirectional illumination.

### SUMMARY OF THE INVENTION

Therefore, an object of the present invention is to provide a light emitting diode lamp that can provide a wider illumination angle.

According to the present invention, a light emitting diode lamp comprises:

a housing having opposite first and second sides, the second side having a first mounting surface, and a tapered protrusion projecting outwardly from the first mounting surface and having at least one inclined second mounting face inclined with respect to the first mounting surface;

a conductive connecting head mounted on the first side of the housing;

alighting unit including a plurality of first light emitting diodes mounted on the first mounting surface of the housing, and a plurality of second light emitting diodes mounted on the second mounting face of the housing;

a driving unit disposed in the housing and coupled to the lighting unit and the conductive connecting head for activating the lighting unit; and

a transparent cap body mounted on the second side of the housing for covering the lighting unit.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective bottom view of a conventional light emitting diode lamp;

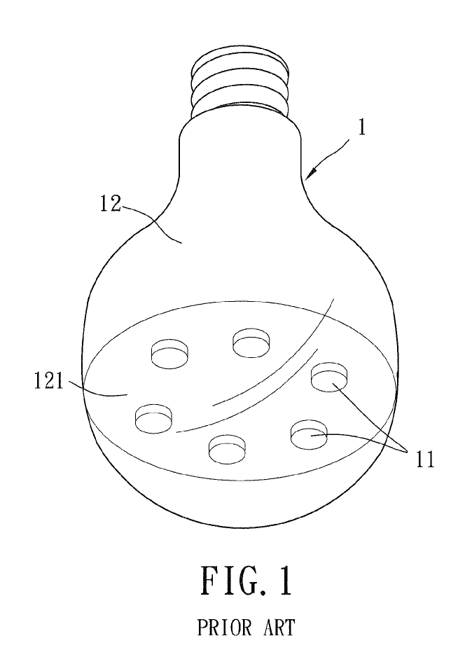

FIG. 2 is a perspective bottom view showing the first preferred embodiment of a light emitting diode lamp according to the present invention;

FIG. 2a is a schematic circuit block diagram illustrating the first preferred embodiment;

FIG. 3 is a schematic side view showing the first preferred embodiment;

FIG. 4 is a perspective bottom view showing the second preferred embodiment of a light emitting diode lamp according to the present invention;

FIG. 5 is a schematic view showing the third preferred embodiment of a light emitting diode lamp according to the present invention; and

FIG. 6 is a schematic bottom view showing the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

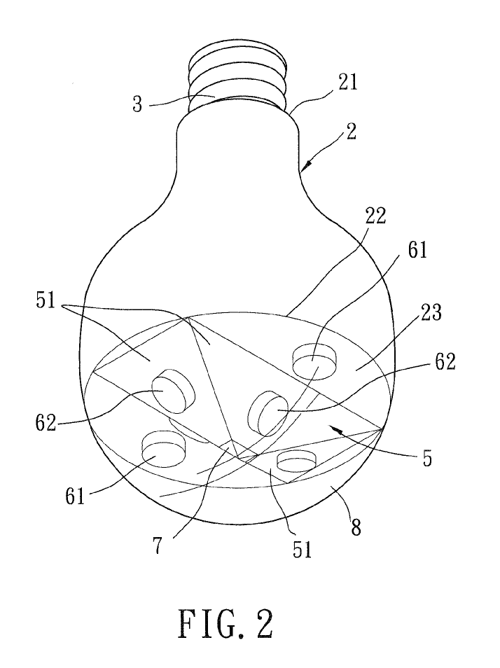

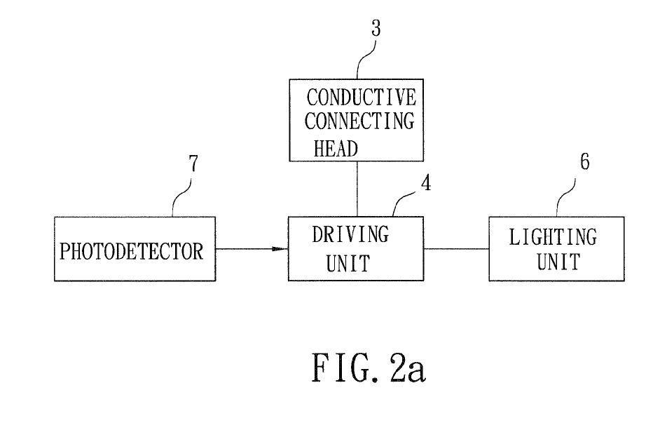

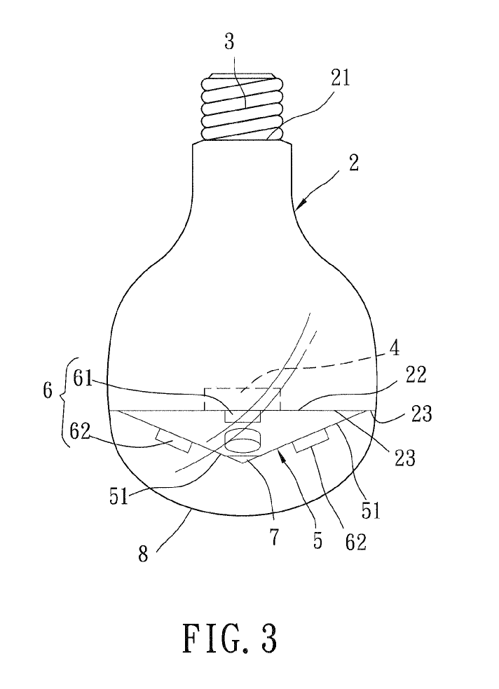

Referring to FIGS. 2, 2a and 3, the first preferred embodiment of a light emitting diode lamp according to the present invention is shown to include a housing 2, a conductive connecting head 3, a lighting unit 6, a driving unit 4, a photodetector 7, and a transparent cap body 8.

The housing 2 has a first side 21 mounted with the connecting head 3 thereon, and a second side 22 opposite to the first side 21. The second side 22 has a first mounting surface 23, and a tapered protrusion 5 projecting outwardly from the first mounting surface 23. In this embodiment, the tapered protrusion 5 is in the form of a truncated polyhedral cone, and has a rectangular cross-section and four inclined second mounting faces 51 inclined with respect to the first mounting surface 23.

The connecting head 3 is adapted to be mounted in a lamp seat for a lamp bulb (not shown).

The lighting unit 6 includes a plurality of first light emitting diodes 61 mounted on the first mounting surface 23 of the housing 2, and a plurality of second light emitting diodes 62 mounted respectively on the second mounting faces 51.

The driving unit 4 is disposed in the housing 2, and is coupled to the lighting unit 6 and the conductive connecting head 3 for activating the lighting unit 6.

The cap body 8 is mounted sealingly on the second side 22 of the housing 2 for covering the lighting unit 6. In this embodiment, the cap body 8 cooperates with the housing 2 to constitute a bulb body.

The photodetector 7 is mounted on a tip of the tapered protrusion 5 of the housing 2, and is coupled to the driving unit 4 for detecting ambient light illumination and for outputting to the driving unit 4 an output corresponding to the ambient light illumination detected thereby such that the driving unit 4 activates the lighting unit 6 based on the output from the photodetector 7. For example, the driving unit 4 activates the first light emitting diodes 61 of the lighting unit 6 and deactivates the second light emitting diodes 62 of the lighting unit 6 upon detecting that the ambient light illumination detected by the photodetector 1 is less than a predetermined illumination, and then further activates the second light emitting diodes 62 upon detecting the same. In another example, the driving unit 4 activates the lighting unit 6 based on the output from the photodetector 7 so that a total number of the first and second light emitting diodes 61, 62 activated by the driving unit 4 corresponds to the ambient illumination detected by the photodetector 7, thereby providing an automatic dimming function. It is noted that operation of the driving unit 4 is limited to the aforesaid examples.

In such a configuration, due to the presence of the inclined second mounting faces 52 mounted with the second light emitting diodes 62 thereon, the light emitting diode lamp of the present invention can provide an illumination angle wider than 180°.

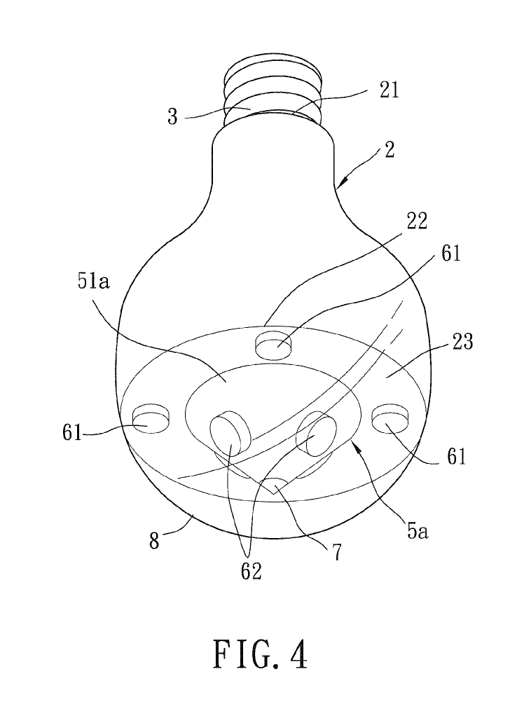

FIG. 4 illustrates the second preferred embodiment of a light emitting diode lamp according to this invention, which is a modification of the first preferred embodiment. Unlike the first preferred embodiment , the tapered protrusion (5a) is in the form of a truncated cone, and has a cone-shaped surface serving as the second mounting face (51a). The first light emitting diodes 61 are spaced apart from each other and are angularly equidistant. The second light emitting diodes 62 are mounted spacedly on the second mounting face (51a) and are angularly equidistant.

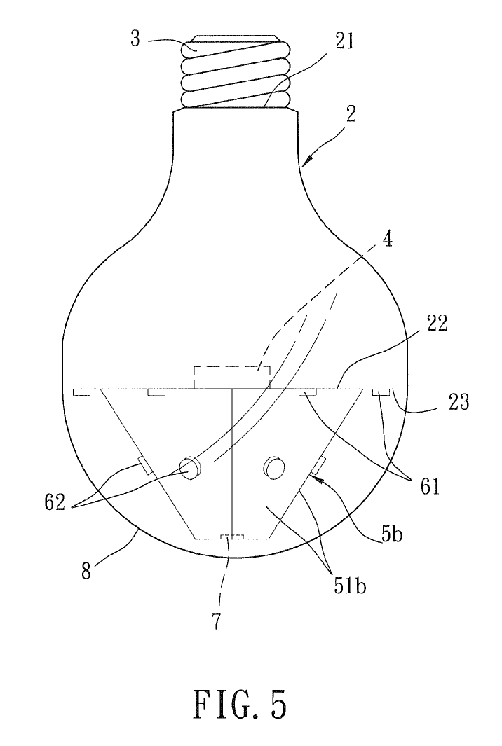

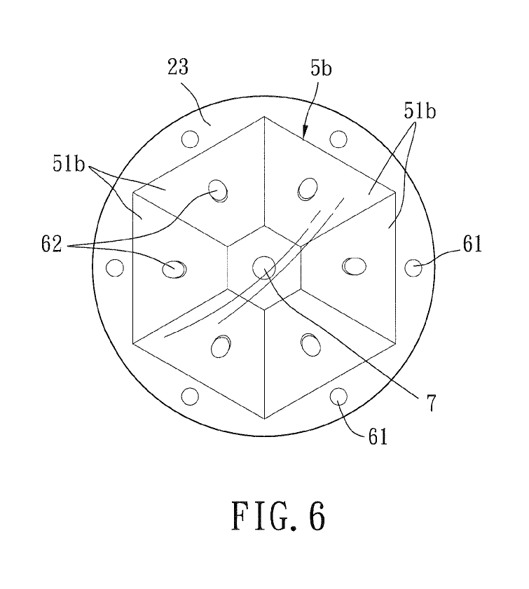

FIGS. 5 and 6 illustrate the third preferred embodiment of a light emitting diode lamp according to this invention, which is a modification of the first preferred embodiment. Unlike the first preferred embodiment, the tapered protrusion (5b) is in the form of a truncated polyhedral cone, and has a hexagonal cross-section and six inclined second mounting faces (51b). The second light emitting diodes 62 are mounted respectively on the second mounting faces (51b). In this embodiment, the light emitting diode lamp of the present invention can provide an illumination angle wider than 240°.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light emitting diode lamp comprising:
a housing having opposite first and second sides, said second side having a first mounting surface, and a tapered protrusion projecting outwardly from said first mounting surface and having at least one inclined second mounting face inclined with respect to said first mounting surface;
a conductive connecting head mounted on said first side of said housing;
alighting unit including a plurality of first light emitting diodes mounted on said first mounting surface of said housing, and a plurality of second light emitting diodes mounted on said second mounting face of said housing;
a driving unit disposed in said housing and coupled to said lighting unit and said conductive connecting head for activating said lighting unit; and
a transparent cap body mounted on said second side of said housing for covering said lighting unit.

2. The light emitting diode lamp as claimed in claim 1, further comprising a photodetector mounted on said tapered protrusion of said housing and coupled to said driving unit for detecting ambient light illumination and for outputting to said driving unit an output corresponding to the ambient light illumination detected thereby such that said driving unit activates said lighting unit based on the output from said photodetector.

3. The light emitting diode lamp as claimed in claim 2, wherein said photodetector is disposed at a tip of said tapered protrusion of said housing.

4. The light emitting diode lamp as claimed in claim 1, wherein said tapered protrusion is in the form of a truncated cone, and has a cone-shaped surface serving as said second mounting face.

5. The light emitting diode lamp as claimed in claim 1, wherein said tapered protrusion is in the form of a truncated polyhedral cone, and has a plurality of said second mounting faces.
